(19) United States
(12) Patent Application Publication
(10) Pub. No.: US 2017/0040756 A1
(43) Pub. Date: Feb. 9, 2017

(54) RADIO FREQUENCY COAXIAL CONNECTOR AND CONNECTION TERMINAL THEREOF

(71) Applicant: Sunway Communication (Beijing) Co., Ltd., Daxing District, Beijing (CN)

(72) Inventors: Jianguang GUO, Beijing (CN); Hongwei ZHANG, Beijing (CN); Yulong WANG, Beijing (CN)

(73) Assignee: Sunway Communication (Beijing) Co., Ltd., Daxing District, Beijing (CN)

(21) Appl. No.: 14/909,898

(22) PCT Filed: Mar. 9, 2015
(86) PCT No.: PCT/CN2015/073873

§ 371 Date: Feb. 3, 2016

(51) Int. Cl. H01R 24/40; H01R 4/02; H01R 4/18

(52) U.S. Cl. CPC H01R 24/40; H01R 4/184; H01R 4/029; H01R 2103/00

(57) ABSTRACT

The present invention discloses a radio frequency coaxial connector and a connection terminal thereof. The connection terminal comprises a terminal body, and one end of the terminal body is a cable connection end. The connection terminal is characterized in that the cable connection end is provided with a pair of second claws which are fixed to the two sides of the cable connection end and face each other; a clamping groove is formed between the second claws and the terminal body; when the second claws are connected with the central conductor, the central conductor is wrapped by the bent portions. The cable connection end is further provided with a welding portion arranged close to the second claws or arranged on the second claws. The connection stability of the connection terminal and central conductor is increased, the electrical performance of the radio frequency coaxial connector is ensured, and the communication quality is improved.

### TECHNICAL FIELD

The present invention relates to a signal connection device, in particular to a radio frequency coaxial connector and a connection terminal thereof

### DESCRIPTION OF RELATED ART

A radio frequency coaxial connector (hereafter referred to as RF connector) is generally regarded as an element which is installed on and connected to an electric cable or installed on an instrument, serves as an element for electrical connection or separation of a transmission line, and belongs to mechatronic products. Simply speaking, the radio frequency coaxial connector mainly has a bridge function.

Generally, the connection structure of a connection terminal in a coaxial connector and a central conductor in the prior art is that two symmetrical claws are arranged at the end of the connection terminal electrically connected with the central conductor of a coaxial line, a groove for containing the central conductor is reserved between the two claws, and the width of the groove is larger than the diameter of the central conductor; when the central conductor is fixedly connected with the connection terminal, inward clamping force is exerted on the two claws, so that the central conductor is tightly clamped by the claws, and electric connection is completed. However, the fixing effect of the electric connection structure is not good, the clamping structure is easily loosened, particularly, after pull force in the length direction of the terminal is exerted, a gap exists between the claws and the central conductor, and the contact area is small. Besides, the central conductor is generally circular, the clamping and fixing difficulty is increased, and consequently, the connection terminal is loosened or detached from the central conductor, and the electrical performance of the radio frequency coaxial connector is directly influenced. Therefore, it is necessary to further improve the coaxial connector.

### BRIEF SUMMARY OF THE INVENTION

The technical aim of the present invention is to provide a radio frequency coaxial connector and a connection terminal thereof to increase the connection stability of the connection terminal and a central conductor, ensure the electrical performance of the radio frequency coaxial connector, and improve the communication quality.

In order to achieve the technical aim, the technical scheme adopted in the present invention is that a connection terminal is provided, the connection terminal comprises a terminal body, one end of the terminal body is a cable connection end, the cable connection end is provided with a pair of second claws, the pair of second claws are fixed to the two sides of the cable connection end and face each other, a clamping groove is formed between the second claws and the terminal body, the distance of the clamping groove is suitable for the inner diameter of the connected central conductor, the second claws comprise base portions and bent portions, and when the second claws are connected with the central conductor, the central conductor is wrapped by the bent portions. The cable connection end is further provided with a welding portion, the welding portion is arranged close to or on the second claws, and the welding portion is fixedly welded to the central conductor.

In order the achieve the technical aim, a radio frequency coaxial connector is provided in another technical scheme adopted in the present invention, the radio frequency coaxial connector is characterized by comprising characterized by comprising a shell, an inner cover and a connection terminal, the inner cover is contained in the shell, and is provided with a central hole and an installation groove extending from the central hole to the edge, the connection terminal is mentioned above, and the connection terminal is arranged in the installation groove, and the pair of first claws are located in the central hole.

The radio frequency coaxial connector and the connection terminal of the radio frequency coaxial connector have the advantages that different from the problem the electrical performance of the radio frequency coaxial connector is directly influenced due to the fact that that a connection terminal is loosened or detached from a central conductor under pulling of external force in the prior art, the present invention provides a connection terminal, a pair of second claws are mainly arranged on a terminal body, on one hand, the outer side of the central conductor is wrapped by the second claws when the central conductor is fixed, the contact area of the central conductor and the second claws is increased, and the loosening phenomenon is unlikely to appear; on the other hand, the welding portion is further arranged, and the welding portion is fixedly welded to the central conductor directly after being connected into the central conductor. By means of the wrapping structure and the welding structure, the problem that the connection terminal is loosened or detached from the central conductor due to pulling of external force can be solved, the connection stability of the connection terminal and the central conductor can be increased, the electrical performance of the radio frequency coaxial connector is ensured, and the communication quality is improved.

### BRIEF DESCRIPTION OF THE SEVERAL VIEWS OF THE DRAWINGS

FIG. 1 is a structure diagram of a connection terminal of the present invention;

FIG. 2 is a connection diagram of a central conductor of a coaxial cable and the connection terminal in the present invention;

FIG. 3 is a diagram of an embodiment for the fixing structure of the central conductor of the coaxial cable and the connection terminal in the present invention;

FIG. 4 is a diagram of the fixing structure of the central conductor of the coaxial cable and the connection terminal in the present invention;

FIG. 5 is a diagram of another embodiment for the fixing structure of the central conductor of the coaxial cable and the connection terminal in the present invention;

FIG. 6 is an integral diagram of the radio frequency coaxial connector in the present invention;

FIG. 7 is a decomposition diagram of the radio frequency coaxial connector in the present invention;

### MARK NUMBER EXPLANATION

Connection terminal: 11, terminal body; 12, second claw; 13, welding portion; 14, third claw; 15, first claw; 121, bent portion; 122, base portion; 123, cut portion; 124, clamping groove; 141, limit groove.

Inner cover: 21, central hole; 22, installation groove; 23, extension strip portion,

Shell: 31, supporting plate portion; 32, opening ring; 33, fastening claw; 331, cable fastening claw; 332, terminal fastening claw; 333, opening ring fastening claw,

Coaxial cable: 41, central conductor.

### DETAILED DESCRIPTION OF THE INVENTION

In order to give detailed description of the technical contents, achieved aims and effect of the present invention, the present invention is explained with a combination of implementation modes and drawings.

The key concept of the present invention is that according to the scheme, a pair of second claws and a welding portion are arranged on a terminal body, on one hand, the outer side of the central conductor is wrapped by the second claws when the central conductor is fixed, the contact area of the central conductor and the second claws is increased, and the loosening phenomenon is unlikely to appear; on the other hand, the welding portion is further arranged, and the welding portion is fixedly welded to the central conductor directly after being connected into the central conductor. By means of the wrapping structure, welding structure and limit structure, the connection stability of the connection terminal and the central conductor can be increased.

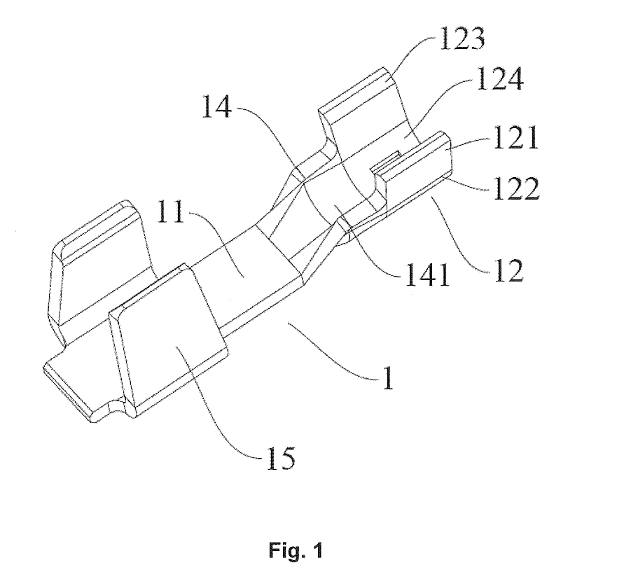

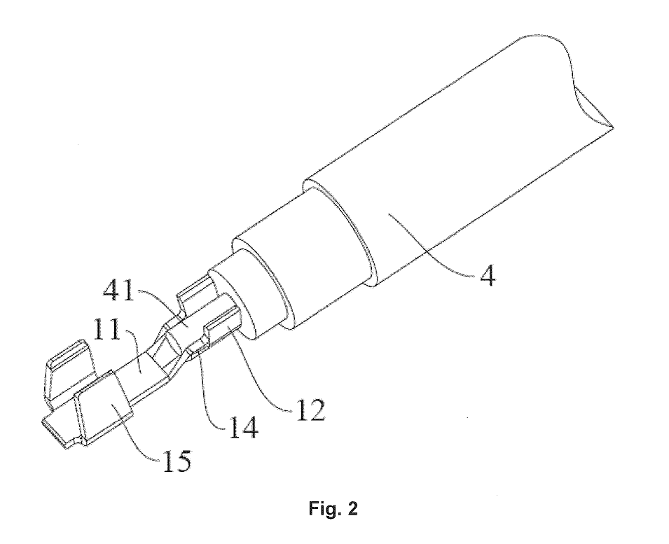

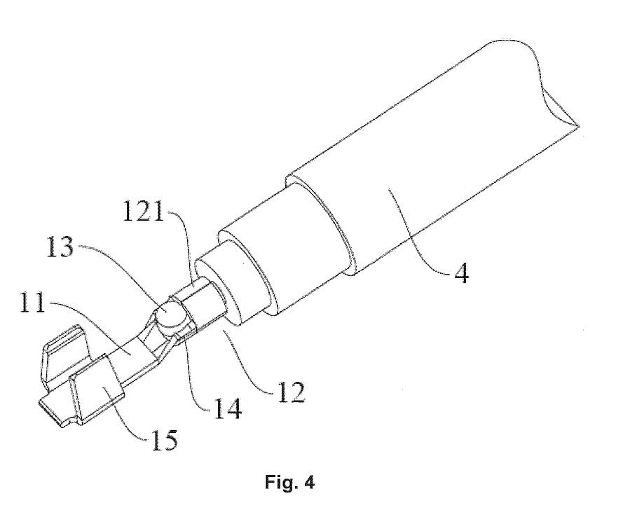

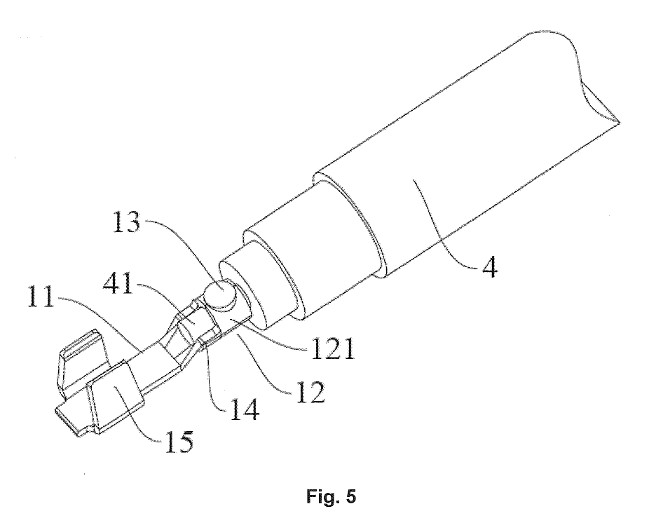

Please refer to FIG. 1 to FIG. 5, the present invention provides a connection terminal, the connection terminal comprises a terminal body 11, one end of the terminal body 11 is a cable connection end, the cable connection end is provided with a pair of second claws 12, the pair of second claws 12 are fixed to the two sides of the cable connection end and face each other, a clamping groove 124 is formed between the second claws 12 and the terminal body 11, the distance of the clamping groove 124 is suitable for the inner diameter of the central conductor 41, the second claws 12 comprise base portions 122 and bent portions 121, and when the second claws 12 are connected with the central conductor 41, the central conductor 41 is wrapped by the bent portions 121. The cable connection end is further provided with the welding portion 13, and the welding portion 13 is arranged close to the second claws 12 and fixedly welded to the extending out end of the central conductor 41 or arranged on the second claws. In the structure, the connection terminal further comprises a pair of third claws 14, a limit groove 141 is formed between the third claws 14 and the terminal body 11, the size of the limit groove 141 is suitable for the inner diameter of the central conductor 41, the limit groove 141 has a limit function on the central conductor 41, the welding portion 13 can be welded to the inner wall of the limit groove 141, and the inner wall comprises the bottom of the limiting groove 141 and the side walls of the limit groove 141. Please refer to FIG. 5, the welding portion 13 can further be arranged on the bent portions 121 and cut portions 123 of the second claws 12.

It can be known from the description that the radio frequency coaxial connector and the connection terminal of the radio frequency coaxial connector have the advantages that different from the problem that the electrical performance of a radio frequency coaxial connector is directly influenced due to the fact that a connection terminal is loosened or detached from a central conductor 41 under pulling of external force in the prior art, the present invention provides a connection terminal, a pair of second claws 12 are mainly arranged on a terminal body 11, on one hand, the outer side of the central conductor 41 is wrapped by the second claws 12 when the central conductor 41 is fixed, the contact area of the central conductor 41 and the second claws 12 is increased, and the loosening phenomenon is unlikely to appear; on the other hand, the welding portion 13 is further arranged, and the welding portion 13 is fixedly welded to the central conductor 41 directly after being connected into the central conductor 41. By means of the wrapping structure and welding structure, the problem that the connection terminal is loosened or detached from the central conductor 41 under pulling of external force can be solved, the connection stability of the connection terminal and the central conductor 41 can be increased, the electrical performance of the radio frequency coaxial connector is ensured, and the communication quality is improved.

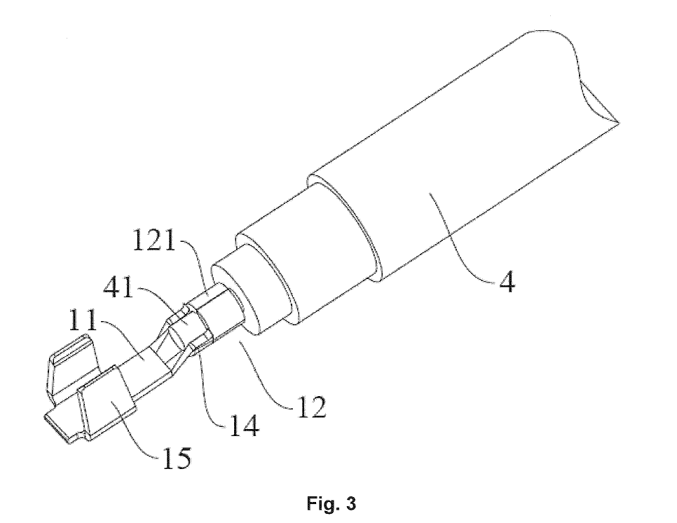

Please refer to FIG. 3 to FIG. 5, as an embodiment, the sum of the curve arc length of the bent portions 121, around the central conductor 41, of the pair of second claws 12 is equal to the exposed arc length of the central conductor 41 so that the second claws 12 can completely cover the surface of the central conductor 41, and no gap is reserved between the second claws 12 and the central conductor 41. The fixing stability is better, but the structure is a complete design of the second claws 12 and the central conductor 41.

As a preferred scheme, the sum of the curve arc length of the bent portions 121, around the central conductor 41, of the pair of second claws 12 is larger than the exposed arc length of the central conductor 41, the bent portions 121 of the pair of second claws 12 are provided with cut portions 123 respectively, and the cut portions 123 comprise inner side cut portions and outer side cut portions matched with the inner side cut portions 123. With consideration of the protrusion problem caused by a gap which is easily reserved in the second claws 12 during bending due to the fact that the curve length of the second claws 12 is larger than the curve arc length of the central conductor 41, the inner side cut portions and the outer side cut portions matched with the inner side cut portions are arranged, the central conductor can be wrapped well, and a small gap is reserved.

Please refer to FIG. 1 to FIG. 5, as an embodiment, the free end of the terminal body 11 is further provided with a pair of first claws 15, and the pair of first claws 15 incline in the direction of the clamping groove so that the respective free ends are close to each other. Therefore, the connection reliability of the connection terminal can further be improved.

Please refer to FIG. 1 to FIG. 4, as an embodiment, the terminal body 11, the pair of first claws 15 and the pair of second claws 12 are integrally formed. In this way, the strength of the connection terminal can be reinforced, and the production process of the connection terminal can be simplified, so that the production cost of the connection terminal can be reduced.

In conclusion, according to the connection terminal provided by the present invention, on one hand, the outer side of the central conductor is wrapped by the second claws when the central conductor is fixed, the contact area of the central conductor and the second claws is increased, and the loosening phenomenon is unlikely to appear; on the other hand, the welding portion is further arranged, and the welding portion is fixedly welded to the central conductor directly after being connected into the central conductor, the structure that the second claws wrap the central conductor and the structure that the welding portion is welded to the central conductor are adopted in the scheme, the problem that the connection terminal is loosened or detached from the central conductor under pulling of external force can be solved, and the connection stability of the connection terminal and the central conductor is remarkably improved.

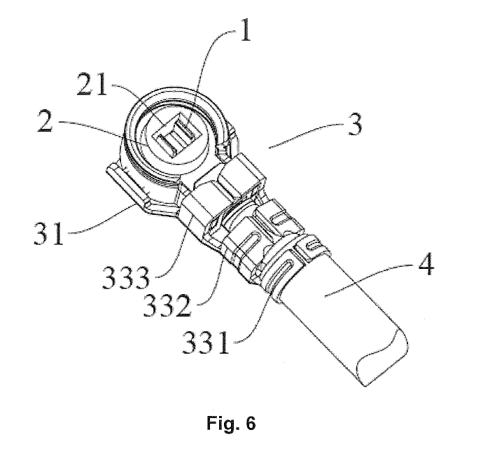

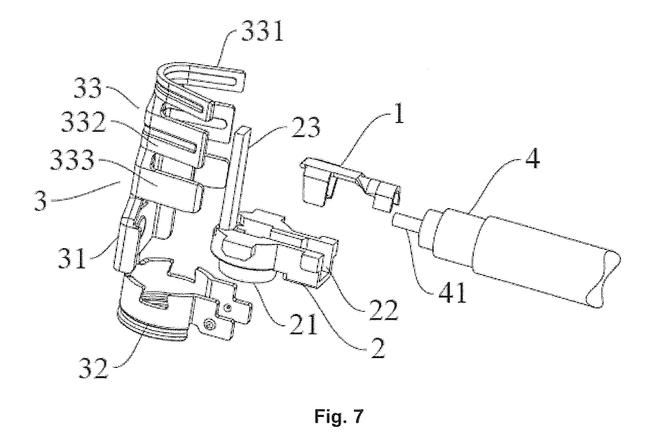

Please refer to FIG. 6 to FIG. 7, the present invention further provides a radio frequency coaxial connector which comprises a shell 3, an inner cover 2 and a connection terminal, the inner cover 2 is contained in the shell 3, and is provided with a central hole 21 and an installation groove 22 extending from the central hole 21 to the edge, the connection terminal 1 is mentioned above, the connection terminal 1 is arranged in the installation groove 22, and the pair of first claws 15 are located in the central hole 21. By means of the connection terminal 1, the coaxial connector can be connected with the coaxial cable more reliably to facilitate stable transmission of signals. The coaxial connector has the advantages of reliable connection with the coaxial cable, stable signal transmission etc.

Please refer to FIG. 6 to FIG. 7, as an embodiment, the shell 3 comprises a supporting plate portion 31 and an opening ring 32 arranged at one end of the supporting plate portion 31, the opening ring 32 is in an irregular ring shape, and the opening of the opening ring 32 faces the other end of the supporting plate portion 31. Therefore, locating installation of the inner cover 2 and the connection terminal 1 can be achieved, and assembling of the coaxial connector is simpler and more convenient.

Please refer to FIG. 6, as an embodiment, fastening claws 33 are arranged along the longitudinal edge of the supporting plate portion 31, so that the structural stability of the coaxial connector and the connection reliability of the coaxial connector and the coaxial cable can be ensured.

Please refer to FIG. 6, as an embodiment, the fastening claws 33 comprise cable fastening claws 331 for fastening the coaxial cable, terminal fastening claws 332 for fastening the connection terminal 1, and opening ring fastening claws 333 for fastening the opening ring. Thus, limit to the opening ring 32, the connection terminal 1 and the coaxial cable 4 can be achieved by the fastening claws 33. The structure is simple, and processing is easy.

Please refer to FIG. 6, as an embodiment, the inner cover 2 is provided with an extension strip portion 23 used for being attached to the surface of the supporting plate portion 31, the extension strip portion 23 can improve the connection stability of the connection terminal 1 and the inner cover 2, and the assembling convenience of the coaxial connector can be further be improved.

In conclusion, according to the radio frequency coaxial connector provided by the present invention, and the coaxial connector is a further application of the connection terminal. By means of the structure that the second claws in the connection terminal wrap the central conductor, the structure that the welding portion is welded to the central conductor and the structure that the limit groove limits the central conductor, the stability of electrical connection performance can be ensured, the communication quality is improved, and the adaptability to the environment is high.

The above presents only several embodiments of the present invention and are not to limit the patent scope of the present invention. Any equivalent changes made by means of the specification or drawing contents of the present invention or direct or indirect application in the relevant technical fields should be included in the patent protection range of the present invention.

1. A connection terminal, comprising a terminal body, one end of the terminal body being a cable connection end, wherein the cable connection end is provided with a pair of second claws, the pair of second claws are fixed to the two sides of the cable connection end and face each other, a clamping groove is formed between the second claws and the terminal body, the distance of the clamping groove is suitable for the inner diameter of the connected central conductor, the second claws comprise base portions and bent portions, and when the second claws are connected with the central conductor, the central conductor is wrapped by the bent portions, the cable connection end is further provided with a welding portion, the welding portion is arranged close to or on the second claws, and the welding portion is fixedly welded to the central conductor.

2. The connection terminal according to claim 1,
wherein the sum of the curve arc length of the bent portions, around the central conductor, of the pair of second claws is equal to the exposed arc length of the central conductor.

3. The connection terminal according to claim 1,
wherein the sum of the curve arc length of the bent portions, around the central conductor, of the pair of second claws is larger than the exposed arc length of the central conductor, the bent portions of the pair of second claws are provided with inner side cut portions and outer side cut portions matched with the inner side cut portions respectively.

4. The connection terminal according to claim 1,
wherein the free end of the terminal body is further provided with a pair of first claws, and the pair of first claws incline in the direction of the clamping groove so that the respective free ends are close to each other.

5. The connection terminal according to claim 4,
wherein the terminal body, the pair of first claws and the pair of second claws are integrally formed.

6. A radio frequency coaxial connector, a shell, an inner cover and a connection terminal, the inner cover is contained in the shell, and is provided with a central hole and an installation groove extending from the central hole to the edge, the connection terminal is claimed in claim 1, the connection terminal is arranged in the installation groove, and the pair of first claws 15 are located in the central hole.

7. The radio frequency coaxial connector according to claim 6,
wherein the shell comprises a supporting plate portion and an opening ring arranged at one end of the supporting plate portion, the opening ring is in an irregular ring shape, and the opening of the opening ring faces the other end of the supporting plate portion.

8. The radio frequency coaxial connector according to claim 7,
further comprising fastening claws are arranged along the longitudinal edge of the supporting plate portion.

9. The radio frequency coaxial connector according to claim 8,
wherein the fastening claws comprise cable fastening claws for fastening a coaxial cable, terminal fastening claws for fastening a connection terminal, and opening ring fastening claws for fastening an opening ring.

10. The radio frequency coaxial connector according to claim 7,
wherein the inner cover is provided with an extension strip portion used for being attached to the surface of the supporting plate portion.

11. A radio frequency coaxial connector, comprising a shell, an inner cover and a connection terminal, the inner cover is contained in the shell, and is provided with a central hole and an installation groove extending from the central hole to the edge, the connection terminal is claimed in claim 2, the connection terminal is arranged in the installation groove, and the pair of first claws 15 are located in the central hole.

12. A radio frequency coaxial connector, comprising a shell, an inner cover and a connection terminal, the inner cover is contained in the shell, and is provided with a central hole and an installation groove extending from the central hole to the edge, the connection terminal is claimed in claim 3, the connection terminal is arranged in the installation groove, and the pair of first claws 15 are located in the central hole.

13. A radio frequency coaxial connector, comprising a shell, an inner cover and a connection terminal, the inner cover is contained in the shell, and is provided with a central hole and an installation groove extending from the central hole to the edge, the connection terminal is claimed in claim 4, the connection terminal is arranged in the installation groove, and the pair of first claws 15 are located in the central hole.

14. A radio frequency coaxial connector, comprising a shell, an inner cover and a connection terminal, the inner cover is contained in the shell, and is provided with a central hole and an installation groove extending from the central hole to the edge, the connection terminal is claimed in claim 5, the connection terminal is arranged in the installation groove, and the pair of first claws 15 are located in the central hole.
